(19) United States
(12) Patent Application Publication
(10) Pub. No.: US 2019/0269110 A1
(43) Pub. Date: Sep. 5, 2019

(54) SYSTEM AND METHOD FOR AQUARIUM WATER REMOVAL

(71) Applicant: PetSmart Home Office, Inc., Phoenix, AZ (US)

(72) Inventors: Jeffrey Stocker Watson, Phoenix, AZ (US); Gary Steven Chattin, Scottsdale, AZ (US)

(21) Appl. No.: 16/275,414

(22) Filed: Feb. 14, 2019

Related U.S. Application Data
(60) Provisional application No. 62/637,764, filed on Mar. 2, 2018.

(51) Int. Cl. A01K 63/04; F04B 19/04

(52) U.S. Cl. CPC A01K 63/047; F04B 17/03; F04B 19/04

(57) ABSTRACT

An system and method for removing water from a vessel such as an aquarium. The system includes at least one water pump mechanism retained within a housing. The system also includes a water inlet coupler extending from the housing, as well as a water outlet coupler extending from the housing. An inlet tube is coupled to the housing, with a second inlet tube end coupled to the water inlet coupler and a first inlet tube end extending into the water within the vessel. An outlet tube is also coupled to the housing, with a first outlet tube end coupled to the water outlet coupler and the second outlet tube end being configured to extend outside of the vessel. The system also includes at least one attachment interface extending from the housing, wherein the at least one attachment interface is configured to retain the housing on the vessel.

### RELATED APPLICATIONS AND CLAIM OF PRIORITY

This patent document claims priority to U.S. Provisional Patent Application No. 62/637,764, filed Mar. 2, 2018, the disclosure of which is fully incorporated into this document by reference.

### BACKGROUND

The present disclosure relates generally to an aquarium and, more particularly, to a system and method for removing and/or replacing some or all of the water within the aquarium.

Aquariums, or fish tanks, are commonly found in household and business settings, in an array of sizes and configurations. An aquarium generally includes a water-tight vessel having at least one transparent sidewall for viewing, with the vessel being at least partially filled with fresh or saltwater in order to provide a living environment for fish and/or other aquatic species. In some configurations, aquariums are temperature-controlled and/or equipped with air pumps so as to maintain appropriate oxygen levels in the water. Additionally, some aquariums are equipped with one or more water pumps and filters, which act to remove undesirable debris from the water within the aquarium.

In order for the artificial ecosystem formed within an aquarium to remain stable and capable of supporting marine life, debris and waste must be periodically removed from the aquarium, with clean water being added periodically, as well. In many instances, the entire volume of water within the aquarium does not need to be replaced, as replacing only a portion of the water suffices to maintain the cleanliness and stability of the aquatic environment. For example, many manufacturers recommend that at least 25% of the water within the aquarium be changed on a weekly basis in order to maintain a suitable environment for the fish or other species.

To change at least a portion of the water within the aquarium, owners have generally had to rely on either manual methods of removal (e.g., the use of containers and/or hand pumps), or utilize specialized submerged electric pumps configured to remove some or all of the water. While the manual methods are workable, they can be time-consuming and untidy. The use of specialized submerged pumps, on the other hand, adds complication and expense to aquarium ownership, and the pumps themselves may be damaged and/or corrode over time. Additionally, in either method, the fish or other species may need to be removed from the aquarium during water change-over, which not only adds complication to the process, but also may stress or injure the fish or other species.

Accordingly, this patent document described devices that are intended to address the issues discussed above and/or other issues.

### SUMMARY

In accordance with one aspect of the disclosure, a system for removing water from a vessel is disclosed. The system includes a vessel having at least one sidewall and configured to hold a volume of water, the at least one sidewall having an inner surface in contact with the water and an outer surface not in contact with the water, and at least one water pump mechanism, wherein the at least one water pump mechanism is retained within a housing. The system also includes a water inlet coupler extending from the housing and in fluid communication with the at least one water pump mechanism, a water outlet coupler extending from the housing and in fluid communication with the at least one water pump mechanism, and an inlet tube having a first inlet tube end and a second inlet tube end, wherein the second inlet tube end is configured to be couplable to the water inlet coupler and the first inlet tube end is configured to extend into the water within the vessel. Additionally, the system includes an outlet tube having a first outlet tube end and a second outlet tube end, wherein the first outlet tube end is configured to be couplable to the water outlet coupler and the second outlet tube end is configured to extend outside of the vessel, and at least one attachment interface extending from the housing, wherein the at least one attachment interface is configured to retain the housing proximate to the outer surface of the at least one sidewall of the vessel.

According to another aspect of the disclosure, a water pump arrangement for removing water from a vessel is disclosed. The water pump arrangement includes at least one pump mechanism, wherein the at least one water pump mechanism is retained within a housing, a water inlet coupler extending from the housing and in fluid communication with the at least one water pump mechanism, and a water outlet coupler extending from the housing and in fluid communication with the at least one water pump mechanism. The water pump arrangement also includes an inlet tube having a first inlet tube end and a second inlet tube end, wherein the second inlet tube end is configured to be removably couplable to the water inlet coupler and the first inlet tube end is configured to extend into the vessel, an outlet tube having a first outlet tube end and a second outlet tube end, wherein the first outlet tube end is configured to be removably couplable to the water outlet coupler and the second outlet tube end is configured to extend outside of the vessel, and at least one attachment interface extending from the housing, wherein the at least one attachment interface is configured to retain the housing on the vessel.

### BRIEF DESCRIPTION OF THE DRAWINGS

FIG. 1 is a perspective view of a water changing pump in accordance with an aspect of the disclosure;

FIG. 2 is a perspective view of the water changing pump of FIG. 1 having inlet and outlet tubing coupled thereto;

FIG. 3 is a partial perspective view of an aquarium having the water changing pump of FIG. 1 coupled thereto;

### DETAILED DESCRIPTION

The following description is made for the purpose of illustrating the general principles of the present system and method and is not meant to limit the inventive concepts claimed in this document. Further, particular features described in this document can be used in combination with other described features in each of the various possible combinations and permutations.

Unless otherwise specifically defined in this document, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to”. Additionally, use the term “couple”, “coupled”, or “coupled to” may imply that two or more elements may be directly connected or may be indirectly coupled through one or more intervening elements.

In this document, position-identifying terms such as “vertical”, “horizontal”, “front”, “rear”, “side”, “top”, and “bottom” are not intended to limit the invention to a particular direction or orientation, but instead are only intended to denote relative positions, or positions corresponding to directions shown when a water pump, aquarium, or related component is oriented as shown in the Figures.

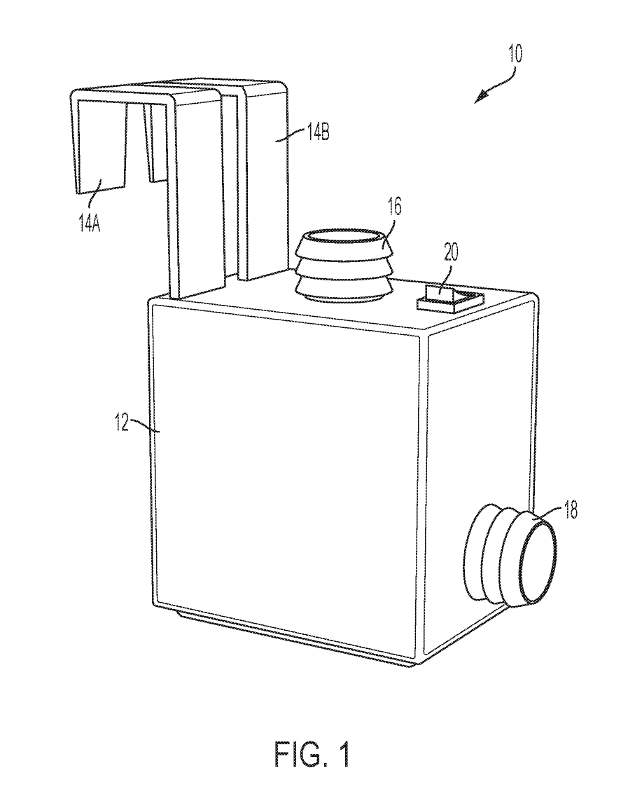

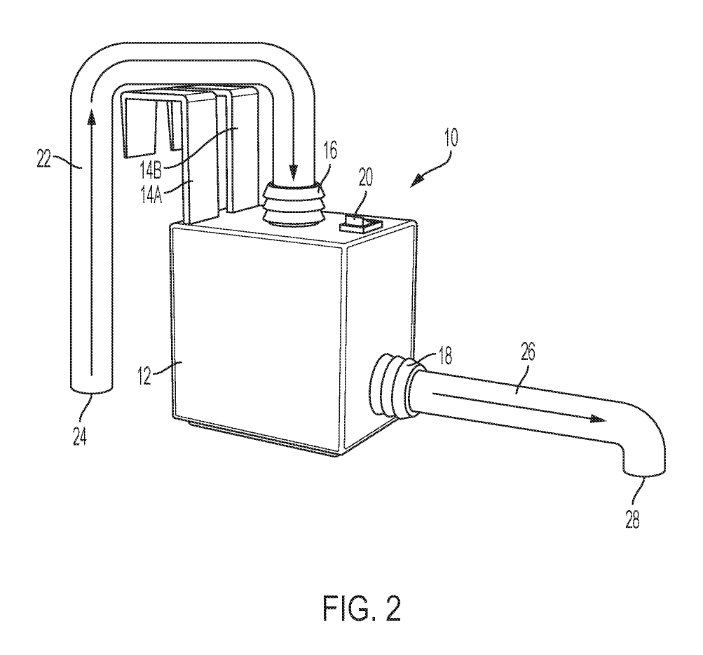

Referring to FIGS. 1-2, in accordance with an aspect of the disclosure, a water pump 10 for use in the removal (or addition) of water from (or to) an aquarium or other water-holding vessel is shown. Water pump 10 includes a housing 12, with housing 12 configured to retain various mechanical and electrical pump components (not shown) therein. In some embodiments, the housing 12 may be environmentally sealed so as to substantially prevent any infiltration of water or contaminants into the housing 12 through openings other than those specifically designated for the inlet/outlet of water to or from the water pump 10.

Additionally, while not shown in FIGS. 1-2, water pump 10 may include more than one pump mechanism therein. That is, water pump 10 may incorporate an initial pump mechanism configured as a priming pump, thereby allowing for the “dry starts” of water pump 10 which may otherwise damage a main pump within housing 12. The priming pump is configured to initially draw water into the main pump, which is larger than the priming pump and is capable of moving larger quantities of water. However, it is to be understood that other pump configurations may be utilized, and water pump 10 may utilize alternative pumping mechanisms and/or fewer (or more) pumping mechanisms.

As shown in FIG. 1, housing 12 includes a water inlet coupler 16 and a water outlet coupler 18. Water inlet coupler 16, as shown, extends from a top portion of housing 12, while water outlet coupler 18 extends from a side portion of housing 12. However, it is to be understood that one or both of water inlet coupler 16 and water outlet coupler 18 may extend from other surfaces of housing 12, and may even extend from the same surface.

Referring to FIG. 2, water inlet coupler 16 and water outlet coupler 18 may be configured as barb fittings, with water inlet coupler 16 configured to retain one end of an inlet tube or hose 22, while water outlet coupler 18 is configured to retain one end of an outlet tube (or hose) 26. The respective ends of inlet tube 22 and outlet tube 26 may expand to fit around water inlet coupler 16 and water outlet coupler 18, respectively, with the barb fitting configuration acting to substantially hold inlet tube 22 and outlet tube 26 in place on housing 12 during a pumping operation. However, while a barb fitting configuration is shown, it is to be understood that water inlet coupler 16 and water outlet coupler 18 may be configured as any appropriate retention fitting, such as, e.g., an interference fit, a threaded coupler, a quick connect hose fitting, etc.

At an end opposite to water inlet coupler 16, inlet tube 22 includes an inlet opening 24. Similarly, at an end opposite to water outlet coupler 18, outlet tube 26 includes an outlet opening 28. As will be described further hereinbelow, inlet opening 24 allows water pump 10 to draw water from an aquarium or other fluid-filled vessel, while the water drawn into water pump 10 is discharged from outlet opening 28. In some embodiments, inlet tube 22 may be formed as a flexible tube, allowing inlet tube 22 to be maneuvered into place within the aquarium or other vessel as desired by the user. The inlet tube 22 may have any appropriate length, dependent upon the particular application. In other embodiments, inlet tube 22 may be cut to a desired length by a user, dependent upon the user's preferences and/or needs. Outlet tube 26 may be configured similarly, with outlet tube 26 being formed as a flexible tube and/or capable of being cut to size, as desired. Alternatively, in other embodiments, inlet tube 22 and/or outlet tube 26 may be substantially or fully rigid.

Referring still to FIGS. 1-2, a switch 20 is provided on a top surface of housing 12, with switch 20 configured to electrically turn on (or off) the pumping mechanism of water pump 10. In other embodiments, switch 20 may be replaced by a dial or other mechanism, which may be configured to allow the user to control the speed, amount, and/or direction of water drawn into, and discharged from, water pump 10. While switch 20 is shown as being disposed on the top surface of housing 12, it is to be understood that switch 20 (or an alternative control interface) could be located on any surface of housing 12.

In order to power the pumping mechanism(s) within housing 12, water pump 10 may include a power cord (not shown) configured to extend to a conventional electrical outlet in the vicinity of the aquarium or other vessel. Alternatively, in other embodiments, water pump 10 may include a dedicated power source (e.g., one or more batteries) within housing 12, with the dedicated power source capable of powering the pumping mechanism(s) within housing 12.

Also extending from a top surface of housing 12 is a pair of hooks 14A, 14B, with each hook 14A, 14B being configurable to hang over an edge of an aquarium or other vessel, as will be set forth in further detail hereinbelow. Hooks 14A, 14B may be rigid, and may be formed of any appropriate material (or combination of materials), such as, e.g., plastic, aluminum, etc. As illustrated in FIGS. 1-2, hooks 14A, 14B may be substantially U-shaped, and may have an overall depth optimized for the size of aquarium/vessel and/or the size of water pump 10. However, it is to be understood that hooks 14A, 14B may be formed in other ways. Additionally, in other embodiments, a single hook may be utilized in lieu of dual hooks 14A, 14B, or more than two hooks may be utilized.

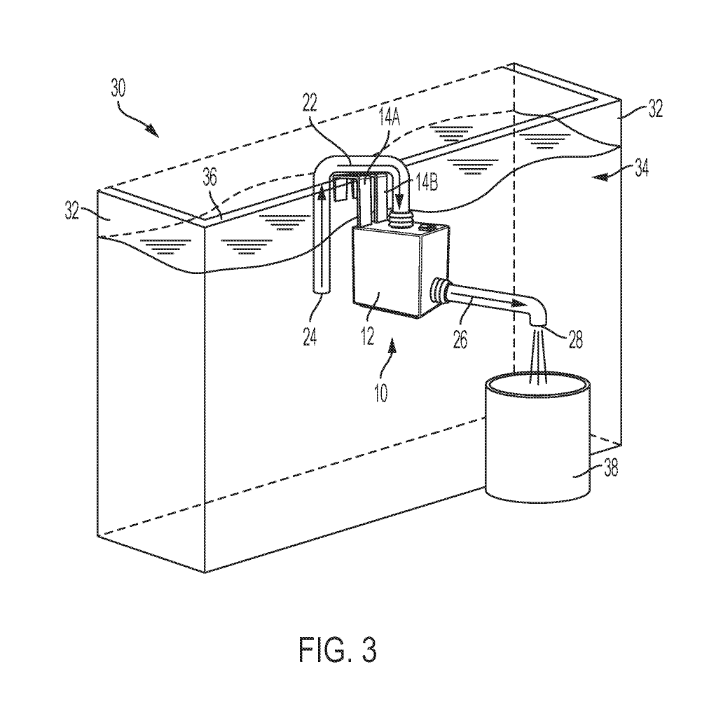

Next, referring to FIG. 3, partial view of an aquarium 30 in accordance with an aspect of the disclosure is illustrated. Aquarium 30 includes sidewalls 32, which may be transparent and/or translucent, and may be formed of any appropriate, water-tight material such as, e.g., glass, polycarbonate, acrylic, etc. Aquarium 30 is configured to hold a volume of water 34 therein, with the depth of water 34 being dependent upon the size of aquarium 30, the environment desired within the aquarium 30, etc. Depending on the species housed within aquarium 30, the water 34 may be either fresh water or salt water. Sidewalls 32 each include a top edge portion 36, which may correspond to the thickness of sidewalls 32 themselves, or may be configured to be wider than the thickness of sidewalls 32.

While the aquarium 30 may incorporate a dedicated filtration system (not shown) which may filter and/or recirculate the water 34 in order to reduce various impurities in the water 34, it is still advisable for at least a portion of the water (e.g., 25%) within aquarium 30 to be removed and replaced on a semi-regular basis in order to introduce clean water free from bacteria, nitrates, and other undesirable toxins into the aquarium 30.

As described above, previous methods of removing water from the main water chamber of aquariums having generally included the use of large containers or hand pumps, which may be untidy and difficult to control. Aquarium 30, on the other hand, may utilize water pump 10 for the removal of some or all of the water from within the aquarium 30 without the need for a user to manually remove water.

As shown in FIG. 3, and in accordance with an aspect of the disclosure, water pump 10 is suspended from the top edge portion 36 of a sidewall 32 by hooks 14A, 14B such that the housing 12 is located on or near an outer surface of sidewall 32. Accordingly, housing 12 is held out of the water 34. While hooks 14A, 14B are shown, it is to be understood that housing 12 may be suspended or held on or near sidewall 32 by other appropriate means such as, e.g., one or more suction cups, etc. In this way, water pump 10 may be removable from aquarium 30 when not in use, providing portability and improved aesthetics. Alternatively, water pump 10 may remain secured to the sidewall 32 of aquarium 30, even when not in operation.

Referring still to FIG. 3, inlet tube 22 is shown extending from housing 12, over sidewall 32, and into water 34 such that inlet opening 24 extends below the surface of water 34. The actual depth below the surface which inlet opening 24 extends may vary and may, in some embodiments, be chosen and/or customized by the user based on the volume of water which the user wishes to remove from the aquarium 30. As noted above, it is often desirable to remove a certain percentage of water within the aquarium (e.g., 25%) at determined intervals (e.g., weekly) in order to maintain a suitable environment for the fish or other species within the aquarium. Thus, in some embodiments, the length of inlet tube 22 may be chosen and/or customized such that this certain percentage of water 34 within aquarium 30 is able to be drawn by water pump 10 through inlet opening 24. Alternatively, the length of inlet tube 22 may be arbitrary, and the volume of water removed from aquarium 30 may be determined and/or controlled in other ways, such as by a measurement made within an outside container used to collect the water.

After water 34 within the aquarium 30 is drawn through inlet tube 22 via the pump mechanism(s) within housing 12, the water is expelled from outlet opening 28 of outlet tube 26. In some embodiments, the water is expelled into a container 38 (e.g., a bucket), which is configured collect the volume of withdrawn water for easy disposal. Alternatively, outlet tube 26 may be of a sufficient length and flexibility to allow water to be directed to a drain or sink located in the vicinity of aquarium 30. With this configuration, the user is able to remove a certain amount of water from aquarium in a clean and orderly fashion, and with minimal disturbance to the environment and species within aquarium 30.

In accordance with some aspects of the disclosure, after removal of a desired amount of water from aquarium 30, the user may manually replace the withdrawn water with a desired amount of new, clean water by simply using a container (such as container 38) to pour the desired amount of replacement water into aquarium 30. However, in other, alternative aspects of the disclosure, water pump 10 may be reversible, thereby allowing water pump 10 to not only remove water from aquarium 30, but also enabling water pump 10 to deliver new water into aquarium 30. That is, water can be drawn from an outside source (e.g., from within container 38), through outlet tube 26, through housing 12, and out of inlet tube 22. In this way, the return/refill of new, clean water into aquarium 30 may be more controlled, thereby reducing the possibility of disturbing the environment, features, species, etc. within aquarium 30.

While the embodiment shown in FIG. 3 pertains to housing 12 of water pump 10 being retained on the outside surface of a sidewall 32 (i.e., outside of water 34), it is to be understood that water pump 10 could be configured in other ways in accordance with alternative embodiments. For example, water pump 10 may be configured to be at least partially submersible within water 34, with housing 12 being suspended in a reverse direction on sidewall 32 as that which is shown in FIG. 3. If the housing 12 is submerged at least partially within water 34, the need for a preliminary priming pump may be obviated. In other possible configurations, the housing 12 may be coupled to a floating buoy or other structure on or within water 34.

Furthermore, while FIG. 3 illustrates water pump 10 being used in conjunction with an aquarium 30, it is to be understood that water pump 10 may be scaled for use with any appropriate fluid-filled vessel such as, e.g., swimming pools, hot tubs, holding tanks, etc.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A system for removing water from a vessel, the system comprising:
a vessel having at least one sidewall and configured to hold a volume of water, the at least one sidewall having an inner surface in contact with the water and an outer surface not in contact with the water;
at least one water pump mechanism, wherein the at least one water pump mechanism is retained within a housing;
a water inlet coupler extending from the housing and in fluid communication with the at least one water pump mechanism;
a water outlet coupler extending from the housing and in fluid communication with the at least one water pump mechanism;
an inlet tube having a first inlet tube end and a second inlet tube end, wherein the second inlet tube end is configured to be couplable to the water inlet coupler and the first inlet tube end is configured to extend into the water within the vessel;
an outlet tube having a first outlet tube end and a second outlet tube end, wherein the first outlet tube end is configured to be couplable to the water outlet coupler and the second outlet tube end is configured to extend outside of the vessel; and
at least one attachment interface extending from the housing, wherein the at least one attachment interface is configured to retain the housing proximate to the outer surface of the at least one sidewall of the vessel.

2. The system of claim 1, wherein the vessel is an aquarium.

3. The system of claim 1, wherein the at least one water pump mechanism comprises a priming pump and a main pump.

4. The system of claim 1, wherein at least one of the water inlet coupler and the water outlet coupler is configured as a barb fitting.

5. The system of claim 1, wherein at least one of the inlet tube and the outlet tube is flexible.

6. The system of claim 1, wherein at least one of the inlet tube and the outlet tube may be cut to a desired length by a user.

7. The system of claim 1, wherein the at least one attachment interface comprises at least one hook.

8. The system of claim 7, wherein the at least one hook is U-shaped.

9. The system of claim 7, wherein the at least one hook is configured to extend over a top edge portion of the at least one sidewall.

10. The system of claim 1, wherein the at least one attachment interface comprises a pair of hooks.

11. The system of claim 10, wherein each of the pair of hooks is U-shaped.

12. The system of claim 10, wherein each of the pair of hooks is configured to extend over a top edge portion of the at least one sidewall.

13. The system of claim 1, wherein the water inlet coupler extends from a top surface of the housing.

14. A water pump arrangement for removing water from a vessel, the water pump arrangement comprising:
at least one pump mechanism, wherein the at least one water pump mechanism is retained within a housing;
a water inlet coupler extending from the housing and in fluid communication with the at least one water pump mechanism;
a water outlet coupler extending from the housing and in fluid communication with the at least one water pump mechanism;
an inlet tube having a first inlet tube end and a second inlet tube end, wherein the second inlet tube end is configured to be removably couplable to the water inlet coupler and the first inlet tube end is configured to extend into the vessel;
an outlet tube having a first outlet tube end and a second outlet tube end, wherein the first outlet tube end is configured to be removably couplable to the water outlet coupler and the second outlet tube end is configured to extend outside of the vessel; and
at least one attachment interface extending from the housing, wherein the at least one attachment interface is configured to retain the housing on the vessel.

15. The water pump arrangement of claim 14, wherein the at least one water pump mechanism comprises a priming pump and a main pump.

16. The water pump arrangement of claim 14, wherein the at least one attachment interface comprises at least one hook.

17. The water pump arrangement of claim 16, wherein the at least one hook is U-shaped.

18. The water pump arrangement of 14, wherein the at least one hook is configured to extend over a top edge portion of the vessel.

19. The water pump arrangement of claim 14, wherein the housing further comprises at least one user interface on a surface thereof, the at least one user interface configured to enable the user control the operation of the at least one pump mechanism.

20. A method of removing water from an aquarium, the method comprising:
providing an aquarium having at least one sidewall and configured to hold a volume of water therein;
providing a water pump arrangement removably couplable to the aquarium, wherein the water pump arrangement comprises:
at least one pump mechanism, wherein the at least one water pump mechanism being retained within a housing,
an inlet tube having a first inlet tube end and a second inlet tube end, wherein the second inlet tube end is configured to be fluidly coupled to the at least one pump mechanism,
an outlet tube having a first outlet tube end and a second outlet tube end, wherein the first outlet tube end is configured to be fluidly coupled to the at least one pump mechanism, and
at least one attachment interface extending from the housing;
coupling the at least one attachment interface to a surface of the aquarium;
extending the first inlet tube end at least partially into water within the aquarium;
extending the second outlet tube end at least partially into a container outside of the aquarium; and
providing electrical power to the at least one pump mechanism such the at least one pump mechanism is activated and at least a portion of the volume of water within the aquarium is drawn into the container outside the aquarium.
